(19) United States
(12) Patent Application Publication
(10) Pub. No.: US 2013/0133770 A1
(43) Pub. Date: May 30, 2013

(54) APPARATUS AND METHOD FOR REPAIRING DAMAGED PIPES

(71) Applicants: Thomas L. Wood, Hudson, WI (US); Mario A. Perez, Burnsville, MN (US)

(72) Inventors: Thomas L. Wood, Hudson, WI (US); Mario A. Perez, Burnsville, MN (US)

(21) Appl. No.: 13/521,755

(22) PCT Filed: Jan. 20, 2011
(86) PCT No.: PCT/US2011/021787

§ 371 Date: Jul. 12, 2012

Related U.S. Application Data
(60) Provisional application No. 61/299,509, filed on Jan. 29, 2010.

(51) Int. Cl. F16L 55/18

(52) U.S. Cl. CPC F16L 55/18
USPC 138/97; 219/643

(57) ABSTRACT

An induction heating device for heating the surface of a pipe or pipeline comprises an induction heating head (100) having a main body (110) and a handle portion (130) extending therefrom. The main body is configured to be removably secured to the surface of the pipe or pipeline and includes a first magnet (121) disposed in a first end (111) and a second magnet (122) disposed in a second end (112). The main body further includes an induction heating portion (150) disposed in a central portion (113) of the main body between the first and second magnets (121, 122). The handle portion includes a grip area extended from the main body.

### BACKGROUND

1. Field of the Invention

The present invention is directed to an apparatus and method for repairing damaged pipes.

2. Related Art

Pipelines and pipes for underground and above-ground installation and use are subject to harsh environmental conditions. Various single layer and multi-layer coatings, such as fusion bonded epoxy (FBE) coatings, and others, are known and are used to provide the pipes with corrosion resistance.

U.S. Pat. No. 5,709,948 discloses a semi-interpenetrating polymer network (semi-IPN) as a coating for pipes and storage vessels. The semi-IPN coating comprises a fully pre-polymerized uncrosslinked (linear) polyolefin and a crosslinked epoxy polymer.

WO 2007/022031 describes a semi- or full-epoxy/polyolefin interpenetrating polymer network (IPN) that can be utilized as either an overcoat layer or can be directly applied to the surface of a metal substrate, such as a pipe.

From time to time, these pipelines and pipes suffer damage that needs to be repaired.

### SUMMARY OF THE INVENTION

According to a first aspect of the present invention, an induction heating device for heating the surface of a pipe or pipeline comprises an induction heating head having a main body and a handle portion extending therefrom. The main body is configured to be removably secured to the surface of the pipe or pipeline and includes a first magnet disposed in a first end and a second magnet disposed in a second end. The main body further includes an induction heating portion disposed in a central portion of the main body between the first and second magnets. The handle portion includes a grip area extended from the main body.

In another aspect, the induction heating device further comprises a power supply electrically coupled to the induction heating head to provide current to the induction heating portion.

In another aspect, the induction heating device further comprises a temperature sensor disposed in at least one of the main body and handle to provide a temperature of a pipe surface proximate to the induction heating device.

In another aspect, the induction heating device further comprises a pad disposed on an underside of the central portion of the main body.

In another aspect, the induction heating device further comprises a switch disposed on the grip area to allow a user to turn the induction heating device on or off.

In another aspect, the induction heating device further comprises a visual indicator disposed on at least one of the main body and handle to indicate to a user that the induction heating portion is activated.

In another aspect, the induction heating device further comprises a proximity sensor to detect the proximity of a pipe surface to the main body.

According to another aspect of the present invention, a pipe repair system comprises an induction heating device for heating the surface of a pipe. The induction heating device comprises an induction heating head having a main body removably securable to a pipe surface and a handle portion extending from the main body. The main body includes first and second magnets disposed at first and second ends thereof and an induction heating portion disposed in a central portion of the main body between the first and second magnets. The pipe repair system further includes a power supply for supplying current to the induction heating device. The pipe repair system also includes a repair patch disposable onto a damaged area on the surface of the pipe, the repair patch formed from a IPN, semi-IPN material.

In another aspect, the pipe repair system comprises a repair patch that further includes a release liner disposed thereon to prevent the repair patch from adhering to the induction heating device.

According to another aspect of the present invention, a method of repairing a damaged pipe comprises pre-heating a surface of the damaged pipe at a damage area to a first temperature via induction heating, applying a repair patch to the damage area, the repair patch formed from a IPN, semi-IPN material, and applying pressure to the repair patch at the damage area while heating the damage area to a second temperature via induction heating.

In another aspect, the method further includes cleaning the damage area prior to pre-heating.

In another aspect, wherein the repair patch further includes a temperature resistant release tape, the method further includes providing for a cool-down period of time after heating the repair patch, wherein after the cool-down period, removing the temperature resistant release tape from the damage area.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The present invention will be further described with reference to the accompanying drawings, wherein:

FIG. 1A is an isometric view of an exemplary induction heating head according to an aspect of the present invention.

FIG. 1B is an exploded view of the exemplary induction heating head of FIG. 1A.

FIG. 1C is an isometric view of an exemplary induction heating core coil configuration according to another aspect of the present invention.

FIG. 2 is a schematic view of an exemplary power supply according to another aspect of the present invention.

FIG. 3 is a view of an exemplary induction heating head to be secured to the surface of a pipe according to another aspect of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The present invention is directed to an apparatus and method for repairing damaged pipes and pipelines. In particular, the induction heating system of the present invention can be utilized with IPN, semi-IPN based repair patches to provide a lightweight, efficient system for repairing damaged pipes and pipelines. Moreover, the efficient induction heating system includes an induction heating head that can provide sufficient localized heating to the damaged pipe without the need for liquid-based or fan-based cooling. The system can sufficiently heat the damaged portion of the pipe so that the IPN, semi-IPN based repair patch bonds with the pipe surface and/or the coated pipe to provide a protective coating to the damaged area of the pipe.

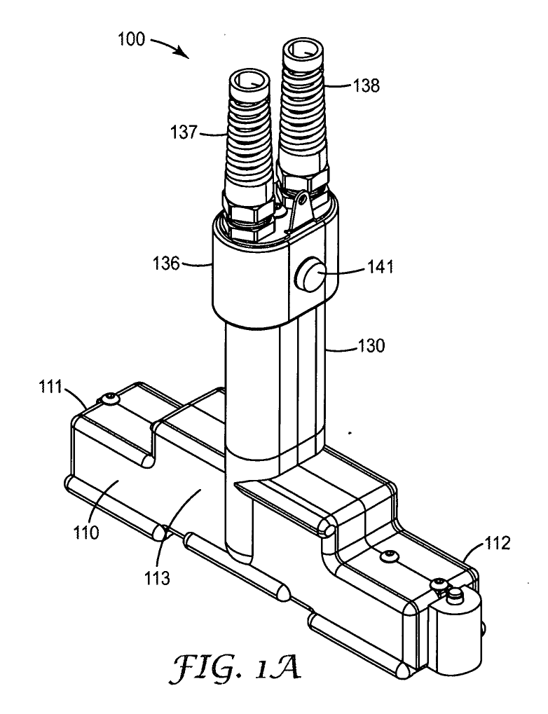

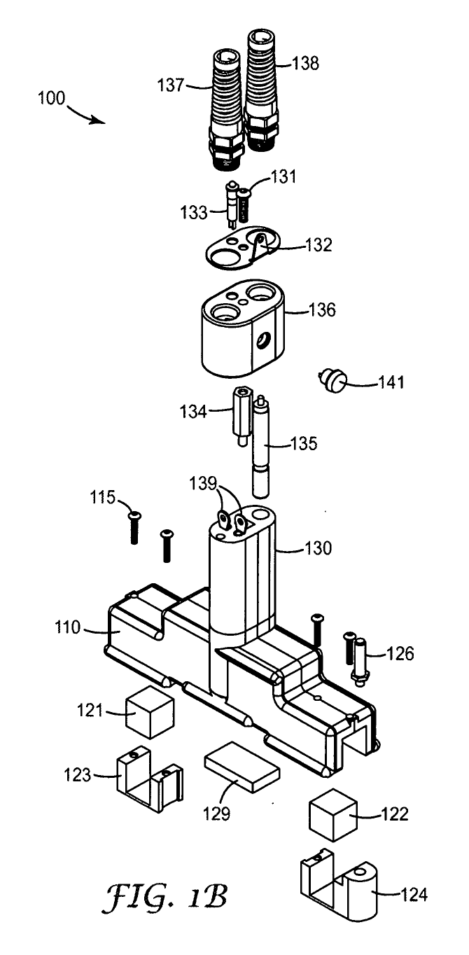

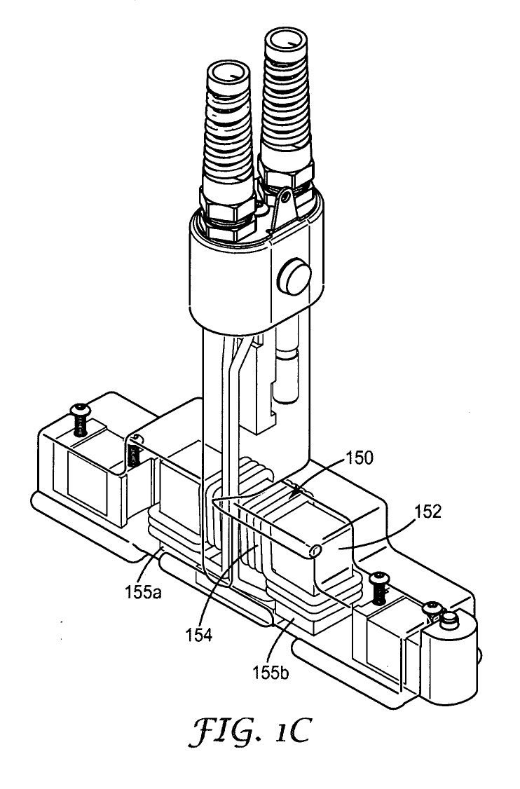

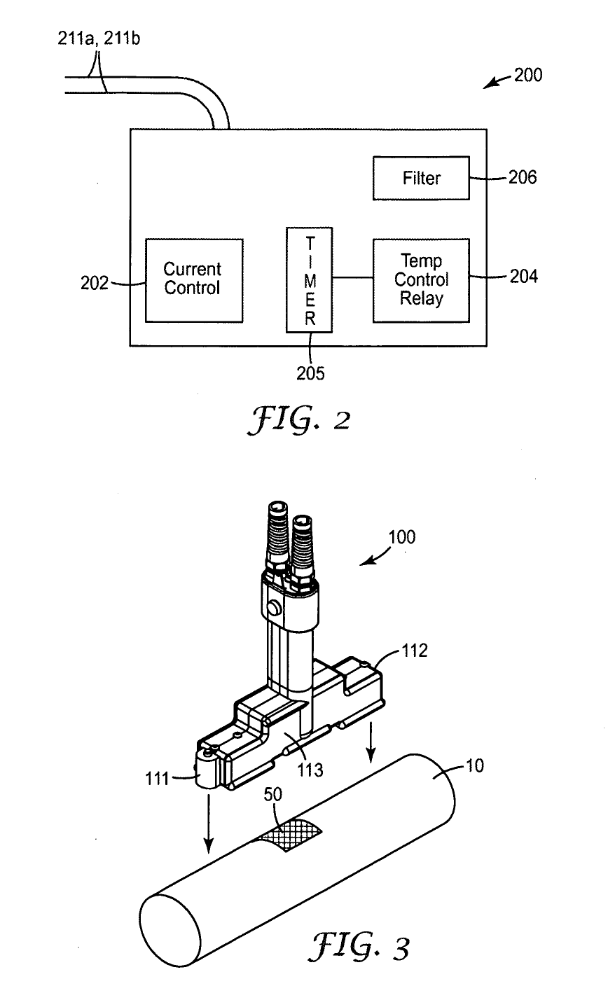

According to a first exemplary embodiment of the present invention, an induction heating system includes an induction heating head 100 (see e.g., FIGS. 1A-1B, referred to as “head 100” herein for simplicity) and a power supply 200 (see FIG. 2).

In particular, as shown in FIG. 1A, head 100 includes a main body 110 and a handle 130. FIG. 1B shows an exploded view of head 100 and the main components housed therein. FIG. 1C shows an exemplary induction heating coil/core configuration.

The main body 110 of head 100 comprises a two part cast resin frame that houses several components therein and is configured to mount onto the curved surface of a pipe (see e.g., FIG. 3). In particular, mounting to a steel pipe can be accomplished utilizing magnets disposed in ends 111 and 112 of the main body 110. For example, rare-earth magnets 121 and 122 can be disposed in mounts 123 and 124, respectively, and can be placed at opposite ends 111, 112 of main body 110. Mounts 123, 124 can be secured in place within main body 110 via conventional fasteners 115. The rare-earth magnets are light weight and possess strong attraction to steel. With this magnet configuration, head 100 can be accurately secured to a pipe surface to keep it stationary during heating. Other types of magnets can also be utilized, as would be apparent to one of ordinary skill in the art given the present description.

Main body 110 of head 100 also houses an induction heating portion 150, seen in detail in FIG. 1C, that is disposed within the central portion 113 of head 110. The induction heating portion 150 includes a modified horseshoe-shaped iron core material 152 surrounded by a wire coil 154. In this configuration, the induction heating portion 150 is positioned at a distance of about 1/16″ to about ¼″ from a pipe surface when in use. In this regard, high frequency (e.g., about 10 KHz) current applied to coil 154 can induce heating on the metal surface disposed proximate to and between the core ends 155a, 155b. This particular coil/core design can be found in commercially available induction heating products, such as the Autotron 3300 system, available from Autotron/Ajax Tocco (Alabama, USA). As the core/coil does not itself heat up when a metal surface is disposed proximate to and between the core ends 155a, 155b, a liquid- or air-based cooling device is not required.

Referring back to FIG. 1B, head 110 can further include a pad or spacer 129 that is disposed on the underside of main body 110, preferably between the core ends 155a, 155b of the induction heating portion. This pad or spacer 129 preferably comprises a silicone-type foam pad of sufficient thickness so that the pad presses onto the repair patch during heating. The foam pad 129 can help ensure sufficient repeatability of the repair process by providing a consistent pressure to each repair patch.

In addition, head 110 can further include a switch or sensor 126, disposed in main body 110 that senses the proximity of the main body 110 to a metal surface. In this regard, the sensor 126 can be used as a safety interlock, whereby the induction heating portion 150 is not activated unless the main body 110 is mounted on or mounted proximate to a pipe or other metal surface.

Head 100 also includes a handle portion 130. Handle portion 130 is configured to be easily gripped by a user so that the head 100 can be properly positioned onto or easily removed from the pipe surface. In addition, handle 130 is configured to extend from the main body 110 by a distance sufficient to provide a suitable lever so that the user can push or pull handle 130 to rock the head 100 to decouple the magnets of the main body 110 from the pipe surface. In a preferred aspect, the handle has a length of from about 3 inches to about 5 inches, with a more preferable length of about 4 inches.

In addition, in a preferred aspect, handle 130 is configured to house a temperature sensor 135 that senses a temperature of the pipe surface being heated (in the present exemplary aspect, heating to a temperature of about 160° C. to about 200° C. is appropriate). In a preferred aspect, the temperature sensor comprises a noncontact infrared (IR) sensor. The sensor 135 communicates with a temperature controller incorporated in the power supply 200 (see FIG. 2) so that the proper current is applied to the induction heating portion 150 of the head 100 (to help avoid under- or over-heating of the pipe surface). In an alternative aspect, the sensor 135 can be housed in the main body 110, although care should be taken to ensure that there is an appropriate distance between the induction coil and the sensor so that induction coil heating does not interfere with the temperature sensor.

Handle 130 can also include a grip portion or cap 136 that provides a convenient grip area for the user. In addition, a start button or switch 141 can be disposed thereon to allow the user to turn the induction heating on when desired. A spacer or other conventional fastener 134 can be used to secure the cap 136 to the handle 130. In addition, the cap 136 can house a visual indicator, such as an LED 133, that provides an indication to the user that the induction heater is, for example, active (LED on) or inactive (LED off). The LED 133 can be coupled to cap 136 via a conventional fastener 131 and mount 132.

Further, the handle can include one or more electrical cord grips 137, 138 each configured to receive an electrical cord from the power supply 200. The cords can be coupled to the induction heating portion 150 via one or more contacts 139.

FIG. 2 shows a schematic view of an exemplary power supply 200. Power supply 200 can be configured as a conventional power supply (see e.g., the power supply for the Autotron 3300 system, available from Autotron/Ajax Tocco (Alabama, USA)), but with additional components for communicating with and controlling head 100. For example, power supply 200 can include a high frequency current generator and controller 202 that provides the appropriate current to the induction heating portion of head 100. In addition, power supply 200 can include a temperature controller relay circuit 204, communicating with temperature sensor 135 (see FIG. 1B), that controls the power supply to maintain a desired temperature at the surface of the pipe being repaired. A timer circuit 205 can be coupled to the temperature controller 204 such that the desired temperature is maintained for an appropriate period of time for, e.g., appropriate pre-heating of the repair site and/or appropriate heating of the repair patch to be properly activated. Alternatively, the temperature controller may have a timer circuit built-in.

In addition, the power supply 200 can further include a filter 206 that filters out high frequency noise and prevents it from feeding back into the power line, as such high frequency noise may trip GFI circuits.

One or more electrical lines 211a, 211b connect the power supply 200 to head 100. These electrical lines can be received by the cord grips 137, 138 disposed in the handle 130 of head 100. (See FIG. 1B)

FIG. 3 shows a schematic view of the exemplary “T-shaped” induction heating head 100 that is to be used to heat a section of a pipe 10 that has been subject to damage. As shown in FIG. 3, head 100 is brought into proximity of pipe 10 such that the repair patch 50 is substantially centered underneath the central portion 113 of the head 100. The magnets located in the ends 111, 112 of head 100 keep the head 100 stationary during the heating process. The pipe 10 is preferably a coated pipe, having an FBE or similar epoxy-based protective coating.

As mentioned previously, the induction heating system of the present invention can be utilized with IPN, semi-IPN based repair patches that cover the damaged pipe section and bond with the pipe coating and/or bare pipe surface to form a new protective layer. IPN, semi-IPN materials can be used to create repair patches or sheets, such as the exemplary patch 50 shown in FIG. 3, as is described in U.S. Publication No. 2007-0036982-A1, incorporated by reference herein in its entirety. The patch 50 can be of single layer or multi-layer construction.

An exemplary method of repairing a damaged pipe will now be described. Once a damage spot on a pipeline is discovered, the damage area can be roughened using a conventional scouring device, such as sand paper. This roughening helps remove surface material and can aid in faster penetration and adhesion of the repair patch into the damage area and surrounding coating.

In a preferred aspect, the induction heating head, such as exemplary head 100 described previously, can be brought into proximity with the damage area and pre-heating of the pipe at the damaged area can be accomplished. In an exemplary aspect, the pipe surface is brought to a temperature of about 160° C. to about 200° C. for a relatively short period of time (about 20 seconds to about 45 seconds). This temperature range corresponds to a temperature greater than the melting point of the patch material, in this example, an IPN material. This pre-heating process can be used to help eliminate moisture that may be exist at the pipe surface and/or epoxy coating at the damage area.

After pre-heating, the induction heating head can be removed and the repair patch can be applied directly to the pre-heated damage area and surrounding coated pipe surface. In a preferred aspect, the patch size is slightly larger than the damage area. In addition, a temperature resistant tape, such as a fiberglass tape or Teflon™ tape, may be placed over the patch as a release layer. Alternatively, the repair patch can include a pre-fitted fiberglass tape cover/release layer that covers the repair patch material. The fiberglass tape is thus disposed between the repair patch and the pressure pad (see e.g., pad 129 from FIG. 1B) of the induction heating head to prevent the repair patch or a portion thereof from adhering to the induction heating head/pressure pad during heating of the repair patch.

The induction heating head is then mounted onto the pipe, with the pressure pad contacting the repair patch. Heat is then applied to the pipe/repair patch at the damage area. For example, depending on the conditions, the pipe surface/repair patch is heated to a temperature of about 160° C. to about 200° C. for a relatively short period of time (about 10 seconds to about 15 seconds). This temperature exceeds the melting point of the repair patch material so that the material may flow to fill any and all discontinuities at the damage area.

After heating, the induction heating head is removed. After a short period of time to allow the pipe surface to cool (e.g., about 30 seconds), the glass tape can be removed from the repair patch.

In an alternative aspect, the induction heating apparatus described herein can be utilized to apply a coating, such as a two part epoxy, to a pipe or pipeline. In certain conditions, such as extremely cold weather conditions, the induction heating head can be secured (via magnet) to the pipe surface to heat the pipe surface to a temperature of at least 160° C. This type of heating can be used to replace flame heating, which can in some circumstances damage epoxy coatings.

Various modifications, equivalent processes, as well as numerous structures to which the present invention may be applicable will be readily apparent to those of skill in the art to which the present invention is directed upon review of the present specification.

We claim:

1. An induction heating device for heating the surface of a pipe or pipeline, comprising:
an induction heating head having a main body and a handle portion extending therefrom, the main body configured to be removably secured to the surface of the pipe or pipeline and including a first magnet disposed in a first end and a second magnet disposed in a second end, wherein the main body further includes an induction heating portion disposed in a central portion of the main body between the first and second magnets, and wherein the handle portion includes a grip area extended from the main body.

2. The induction heating device of claim 1, further comprising:
a power supply electrically coupled to the induction heating head to provide current to the induction heating portion.

3. The induction heating device of claim 1, further comprising:
a temperature sensor disposed in at least one of the main body and handle to provide a temperature of a pipe surface proximate to the induction heating device.

4. The induction heating device of claim 1, further comprising:
a pad disposed on an underside of the central portion of the main body.

5. The induction heating device of claim 1, further comprising:
a switch disposed on the grip area to allow a user to turn the induction heating device on or off.

6. The induction heating device of claim 1, further comprising:
a visual indicator disposed on at least one of the main body and handle to indicate to a user that the induction heating portion is activated.

7. The induction heating device of claim 1, further comprising:
a proximity sensor to detect the proximity of a pipe surface to the main body.

8. A pipe repair system, comprising:
an induction heating device for heating the surface of a pipe, comprising an induction heating head having a main body removably securable to a pipe surface and a handle portion extending from the main body, the main body having first and second magnets disposed at first and second ends thereof and an induction heating portion disposed in a central portion of the main body between the first and second magnets;
a power supply for supplying current to the induction heating device; and
a repair patch disposable onto a damaged area on the surface of the pipe, the repair patch formed from a IPN, semi-IPN material.

9. The pipe repair system of claim 8, wherein the repair patch further includes a release liner disposed thereon to prevent the repair patch from adhering to the induction heating device.

10. A method of repairing a damaged pipe, comprising:
pre-heating a surface of the damaged pipe at a damage area to a first temperature via induction heating;
applying a repair patch to the damage area, the repair patch formed from a IPN, semi-IPN material; and
applying pressure to the repair patch at the damage area while heating the damage area to a second temperature via induction heating.

11. The method of claim 10, further comprising:
cleaning the damage area prior to pre-heating.

12. The method of claim 10, wherein the repair patch further includes a temperature resistant release tape, further comprising:
providing for a cool-down period of time after heating the repair patch, wherein after the cool-down period, removing the temperature resistant release tape from the damage area.
